(19) United States
(12) Patent Application Publication
(10) Pub. No.: US 2018/0253100 A1
(43) Pub. Date: Sep. 6, 2018

(54) MOVING APPARATUS

(71) Applicant: FUJI XEROX CO., LTD., Tokyo (JP)

(72) Inventors: Teppei AOKI, Kanagawa (JP); Kunitoshi YAMAMOTO, Kanagawa (JP); Hideki FUJIMOTO, Kanagawa (JP); Mariko MIYAZAKI, Kanagawa (JP); Hirokazu TSUBOTA, Kanagawa (JP); Hajime KAJIYAMA, Kanagawa (JP); Tetsuya KOBAYASHI, Kanagawa (JP); Naoya OGATA, Kanagawa (JP); Kengo TOKUCHI, Kanagawa (JP); Yasuharu SAKURAI, Kanagawa (JP)

(73) Assignee: FUJI XEROX CO., LTD., Tokyo (JP)

(21) Appl. No.: 15/692,446

(22) Filed: Aug. 31, 2017

(30) Foreign Application Priority Data
Mar. 3, 2017 (JP) 2017-040284

(51) Int. Cl. G05D 1/02; G01S 13/93

(52) U.S. Cl. CPC G05D 1/028; G01S 13/93; G05D 1/0257

(57) ABSTRACT

A moving apparatus includes a moving unit, an operation unit, a detector, and a controller. The moving unit moves to a destination point. The operation unit performs a predetermined operation after movement of the moving unit. The detector detects an obstacle. The controller controls the detector to make a detection distance in an opposite direction to a moving direction of the moving apparatus shorter during the movement of the moving unit than during the operation of the operation unit.

### CROSS-REFERENCE TO RELATED APPLICATIONS

This application is based on and claims priority under 35 USC 119 from Japanese Patent Application No. 2017-040284 filed Mar. 3, 2017.

### BACKGROUND

The present invention relates to a moving apparatus.

### SUMMARY

According to an aspect of the invention, there is provided a moving apparatus including a moving unit, an operation unit, a detector, and a controller. The moving unit moves to a destination point. The operation unit performs a predetermined operation after movement of the moving unit. The detector detects an obstacle. The controller controls the detector to make a detection distance in an opposite direction to a moving direction of the moving apparatus shorter during the movement of the moving unit than during the operation of the operation unit.

### BRIEF DESCRIPTION OF THE DRAWINGS

An exemplary embodiment of the present invention will be described in detail based on the following figures, wherein:

FIG. 1 is a system configuration diagram illustrating a configuration of a service providing system according to an exemplary embodiment of the present invention;

FIG. 2 is a plan view illustrating an office applied to the exemplary embodiment of the present invention;

FIG. 3 is a block diagram illustrating a hardware configuration of a service providing apparatus according to the exemplary embodiment of the present invention;

FIG. 4 is a block diagram illustrating a hardware configuration of an internal server according to the exemplary embodiment of the present invention;

FIG. 5 is a front view for illustrating a sensor of the service providing apparatus according to the exemplary embodiment of the present invention;

FIG. 6 is a flowchart illustrating a control flow of the service providing apparatus according to the exemplary embodiment of the present invention;

FIGS. 7A to 7D are schematic diagrams for illustrating detection operations of the service providing apparatus according to the exemplary embodiment of the present invention;

FIGS. 8A to 8C are schematic diagrams for illustrating modified examples of the detection operation during movement of the service providing apparatus according to the exemplary embodiment of the present invention;

FIG. 9 is a schematic diagram for illustrating a modified example of the detection operation during stop of the service providing apparatus according to the exemplary embodiment of the present invention;

FIGS. 10A and 10B are schematic diagrams for illustrating modified examples of the detection operation during operation of the service providing apparatus according to the exemplary embodiment of the present invention; and

FIGS. 11A and 11B are schematic diagrams for illustrating modified examples of the detection operation during the operation of the service providing apparatus according to the exemplary embodiment of the present invention.

### DETAILED DESCRIPTION

An exemplary embodiment of the present invention will now be described in detail with reference to the drawings.

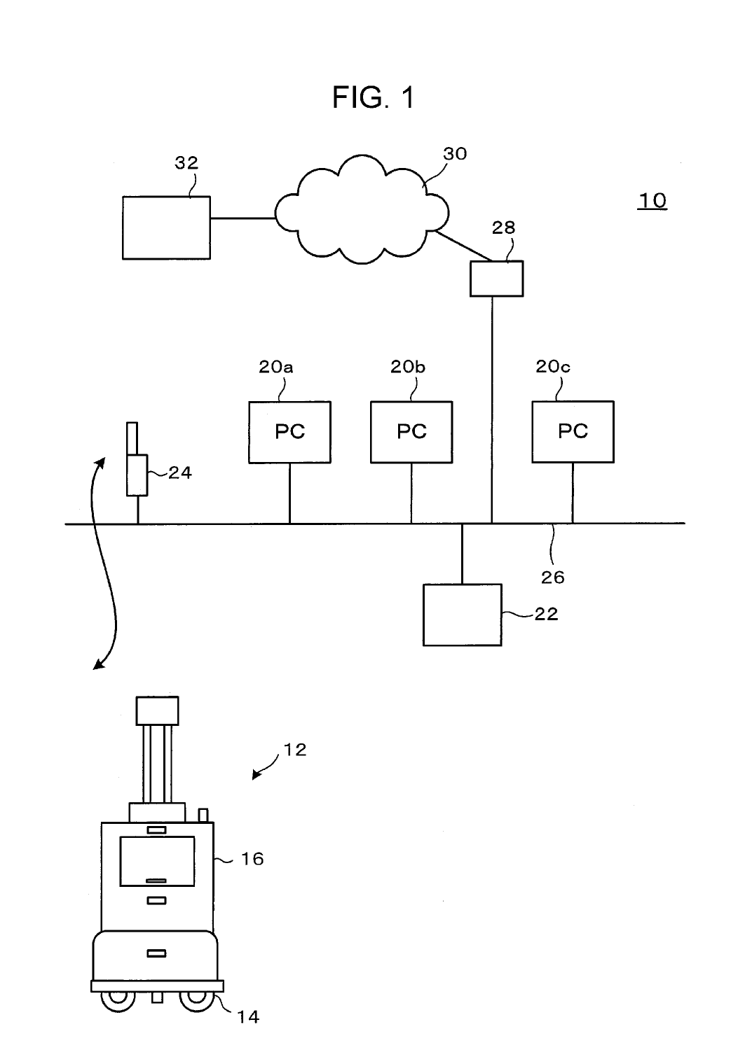

FIG. 1 is a system diagram illustrating a configuration of a service providing system 10 according to an exemplary embodiment of the present invention.

The service providing system 10 includes a service providing apparatus 12 serving as a moving apparatus that moves to provide a service, for example. The service providing apparatus 12 includes a moving unit 14 serving as a moving unit to be freely movable in an office, for example. The service providing apparatus 12 serves foods and drinks, and the moving unit 14 is mounted with a service providing unit 16 serving as an operation unit.

Further, in the service providing system 10, multiple personal computers (PCs) 20a to 20c, an internal server 22, and a wireless local area network (LAN) terminal 24 are connected via a local network 26. Further, the local network 26 is connected, via a router 28, to the Internet 30, which is connected to an external server 32.

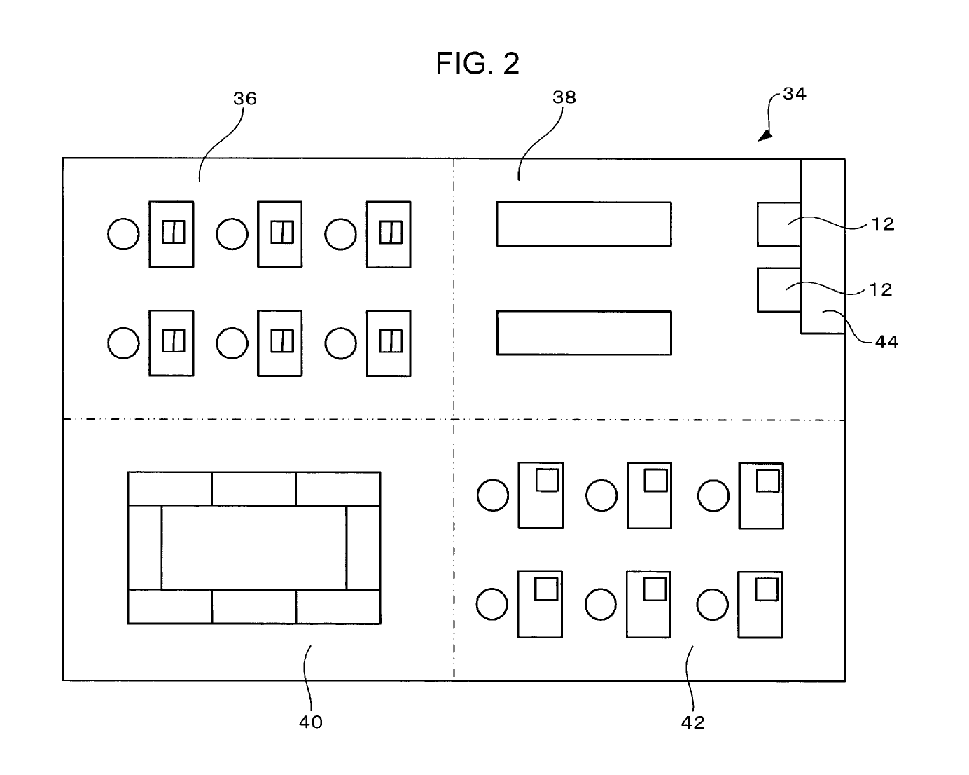

FIG. 2 is a plan view illustrating an office 34 equipped with service providing apparatuses 12.

The office 34 is divided into plural areas, such as a PC operation area 36, a laboratory area 38, a meeting area 40, and a telephone call operation area 42, for example. Each of the areas 36 to 42 is provided with multiple PCs. Further, the office 34 includes a storage 44 that stores goods. The plural service providing apparatuses 12 are capable of bringing goods to be served from the storage 44. The position of the storage 44 may be set as the home position of the service providing apparatuses 12.

The office 34 is not necessarily located on one floor, and may be located on plural floors. If the office 34 is located on plural floors, the service providing apparatus 12 is capable of moving up and down between the offices 34 via an elevator, for example.

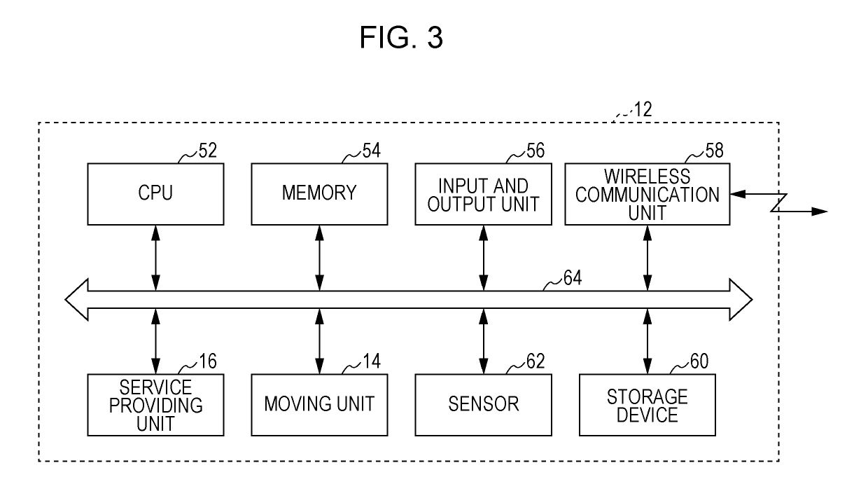

FIG. 3 is a block diagram illustrating a control configuration of the service providing apparatus 12.

The service providing apparatus 12 includes a central processing unit (CPU) 52 serving as a controller, a memory 54, an input and output unit 56, a wireless communication unit 58, a storage device 60, the service providing unit 16, the moving unit 14, and a sensor 62 serving as a detector, which are connected by a control bus 64.

The CPU 52 executes a predetermined process based on a control program stored in the memory 54.

The input and output unit 56 receives input information, such as an identification (ID) or password of a user. The input and output unit 56 includes an ID input unit to which the ID of the user is input from an integrated circuit (IC) card, for example. The input and output unit 56 further includes devices such as a camera and a microphone to acquire information at a departure point, during the movement, and at a destination point. For example, the camera photographs the face of the user to confirm the identity of the user. The microphone acquires audio data of the user or surroundings of the user. The input and output unit 56 further includes a device such as a display that displays and outputs screen display data and input buttons serving as a user interface, the state of audio output from a speaker, and the state of the service providing apparatus 12.

The wireless communication unit 58 transmits and receives data to and from the wireless LAN terminal 24 via a wireless line.

The storage device 60 stores a map of the office 34 equipped with apparatuses such as the PCs 20a to 20c.

The service providing unit 16 performs a predetermined operation of serving drinks such as juice and coffee, for example, and serving foods such as snacks, for example. Further, the service providing unit 16 selects and serves juice from various menu items such as orange juice and apple juice, or extracts and serves coffee from various menu items such as hot coffee, café latte, and iced coffee.

If the CPU 52 receives a move command from the foregoing internal server 22 via the wireless communication unit 58, the CPU 52 controls the moving unit 14 to move to the destination point in accordance with the move command.

The sensor 62 detects the distance to the destination point and an obstacle on a path to the destination point. Herein, the obstacle includes a dynamic obstacle that moves with time, such as a person, and a static obstacle that does not move with time, such as an object.

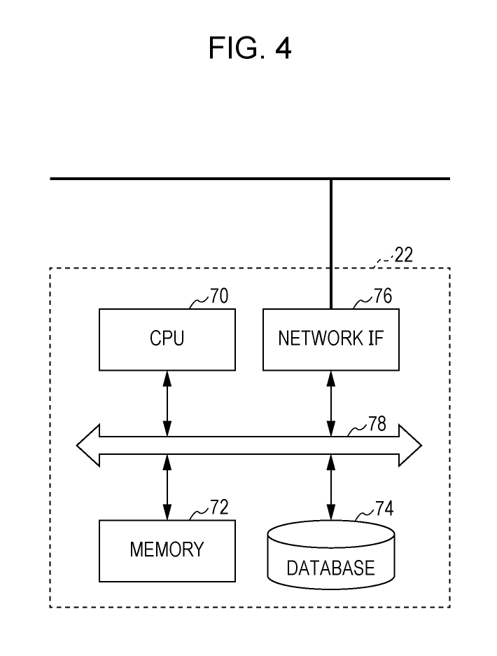

FIG. 4 is a block diagram illustrating a control section of the internal server 22.

The internal server 22 includes a CPU 70, a memory 72, a database 74, and a network interface (IF) 76, which are connected via a control bus 78. The CPU 70 executes a predetermined process based on a control program stored in the memory 72 to control the operation of the internal server 22. The memory 72 stores the control program. Further, the database 74 stores, as a database, information such as authentication information of the user, position information of the user (the position of a registered PC of the user and the position of the user based on the schedule of the user), the map of the office 34, and service provision information.

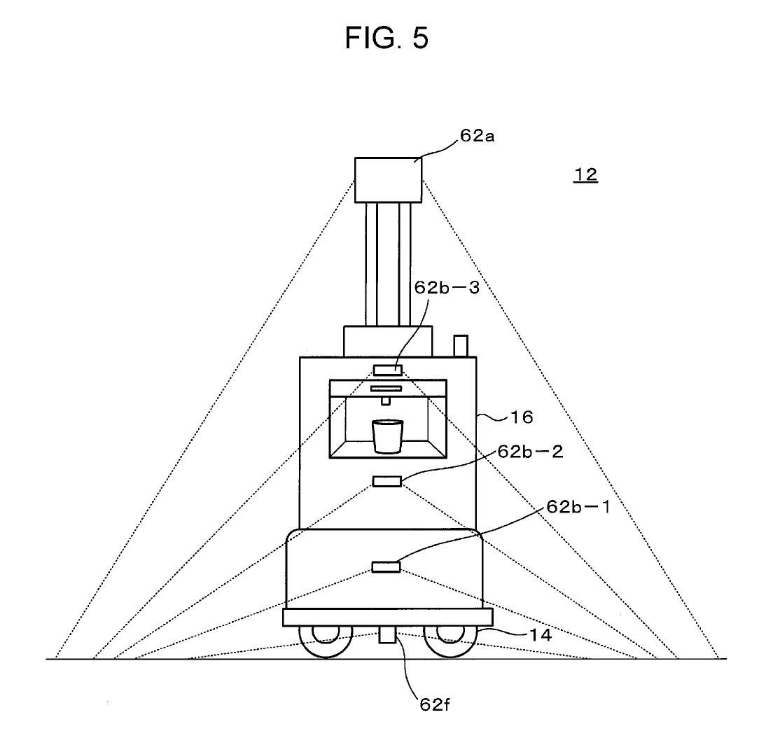

FIG. 5 is a diagram illustrating the sensor 62 employed in the service providing apparatus 12.

The sensor 62 detects the position and the moving direction of the service providing apparatus 12. The sensor 62 further detects the distance with laser light, for example, and detects the state of surroundings thereof and an obstacle on the path. The sensor 62 further identifies and detects the distance from the position of the service providing apparatus 12 to the destination point.

The sensor 62 is configured of a sensor 62a provided above an upper surface of the service providing apparatus 12, a sensor 62b provided on a front surface of the service providing apparatus 12, a sensor 62c (not illustrated in FIG. 5) provided on a rear surface of the service providing apparatus 12, sensors 62d and 62e (not illustrated in FIG. 5) provided on side surfaces of the service providing apparatus 12, and a sensor 62f provided on a lower surface of the service providing apparatus 12.

The sensor 62a is an obstacle detecting sensor that detects an obstacle all around the service providing apparatus 12 (in 360 degrees) and a position detecting sensor that detects the position of the service providing apparatus 12. Further, the sensor 62f is an obstacle detecting sensor that detects an obstacle all around surroundings of the moving unit 14 below the service providing apparatus 12.

The sensors 62b, 62c, 62d, and 62e are obstacle detecting sensors that detect an obstacle in front of, behind, and lateral to the service providing apparatus 12, respectively, to detect an obstacle within a predetermined distance from the front surface, the rear surface, and the side surfaces of the service providing apparatus 12.

The sensor 62b is configured of a sensor 62b-1 provided on a lower part of the front surface of the service providing apparatus 12, a sensor 62b-3 provided on an upper part of the front surface of the service providing apparatus 12, and a sensor 62b-2 provided between the sensors 62b-1 and 62b-3.

The sensor 62c is configured of a sensor 62c-1 provided on a lower part of the rear surface of the service providing apparatus 12, a sensor 62c-3 provided on an upper part of the rear surface of the service providing apparatus 12, and a sensor 62c-2 provided between the sensors 62c-1 and 62c-3.

The sensor 62d is configured of a sensor 62d-1 provided on a lower part of one of the side surfaces of the service providing apparatus 12, a sensor 62d-3 provided on an upper part of the side surface of the service providing apparatus 12, and a sensor 62d-2 provided between the sensors 62d-1 and 62d-3. The sensor 62e is configured of a sensor 62e-1 provided on a lower part of the other one of the side surfaces of the service providing apparatus 12, a sensor 62e-3 provided on an upper part of the side surface of the service providing apparatus 12, and a sensor 62e-2 provided between the sensors 62e-1 and 62e-3.

A detection distance of the sensor 62b-3 from the front surface of the service providing apparatus 12 is longer than a detection distance of the sensor 62b-2 from the front surface of the service providing apparatus 12, which is longer than a detection distance of the sensor 62b-1 from the front surface of the service providing apparatus 12. That is, the sensors 62b-1, 62b-2, and 62b-3 detect an obstacle in a short distance, an intermediate distance, and a long distance from the front surface of the service providing apparatus 12, respectively.

Similarly, a detection distance of the sensor 62c-3 from the rear surface of the service providing apparatus 12 is longer than a detection distance of the sensor 62c-2 from the rear surface of the service providing apparatus 12, which is longer than a detection distance of the sensor 62c-1 from the rear surface of the service providing apparatus 12. That is, the sensors 62c-1, 62c-2, and 62c-3 detect an obstacle in a short distance, an intermediate distance, and a long distance from the rear surface of the service providing apparatus 12, respectively.

Further, similarly, a detection distance of the sensor 62d-3 from the corresponding side surface of the service providing apparatus 12 is longer than a detection distance of the sensor 62d-2 from the side surface of the service providing apparatus 12, which is longer than a detection distance of the sensor 62d-1 from the side surface of the service providing apparatus 12. That is, the sensors 62d-1, 62d-2, and 62d-3 detect an obstacle in a short distance, an intermediate distance, and a long distance from the side surface of the service providing apparatus 12, respectively.

Further, similarly, a detection distance of the sensor 62e-3 from the corresponding side surface of the service providing apparatus 12 is longer than a detection distance of the sensor 62e-2 from the side surface of the service providing apparatus 12, which is longer than a detection distance of the sensor 62e-1 from the side surface of the service providing apparatus 12. That is, the sensors 62e-1, 62e-2, and 62e-3 detect an obstacle in a short distance, an intermediate distance, and a long distance from the side surface of the service providing apparatus 12, respectively.

Further, the CPU 52 switches respective power supplies of the short-distance sensors 62b-1, 62c-1, 62d-1, and 62e-1, the intermediate-distance sensors 62b-2, 62c-2, 62d-2, and 62e-2, and the long-distance sensors 62b-3, 62c-3, 62d-3, and 62e-3 provided on the front, rear, right, and left surfaces of the service providing apparatus 12, to thereby change the detection distance (detection range) from each of the surfaces of the service providing apparatus 12.

The detection distance of the sensor 62a is longer than any of the detection distances of the sensors 62b-3, 62c-3, 62d-3, and 62e-3. The sensor 62a is configured to detect an obstacle in a farther distance.

Further, the sensor 62a is also used to detect the position of the service providing apparatus 12 by detecting the shape of the surroundings, and thus constantly performs the detection of an object all around the service providing apparatus 12 in 360 degrees. The CPU 52, however, limits a detection range in which the object detected by the sensor 62a is detected as an object that may collide with the service providing apparatus 12, to thereby change an obstacle detection range of the sensor 62a.

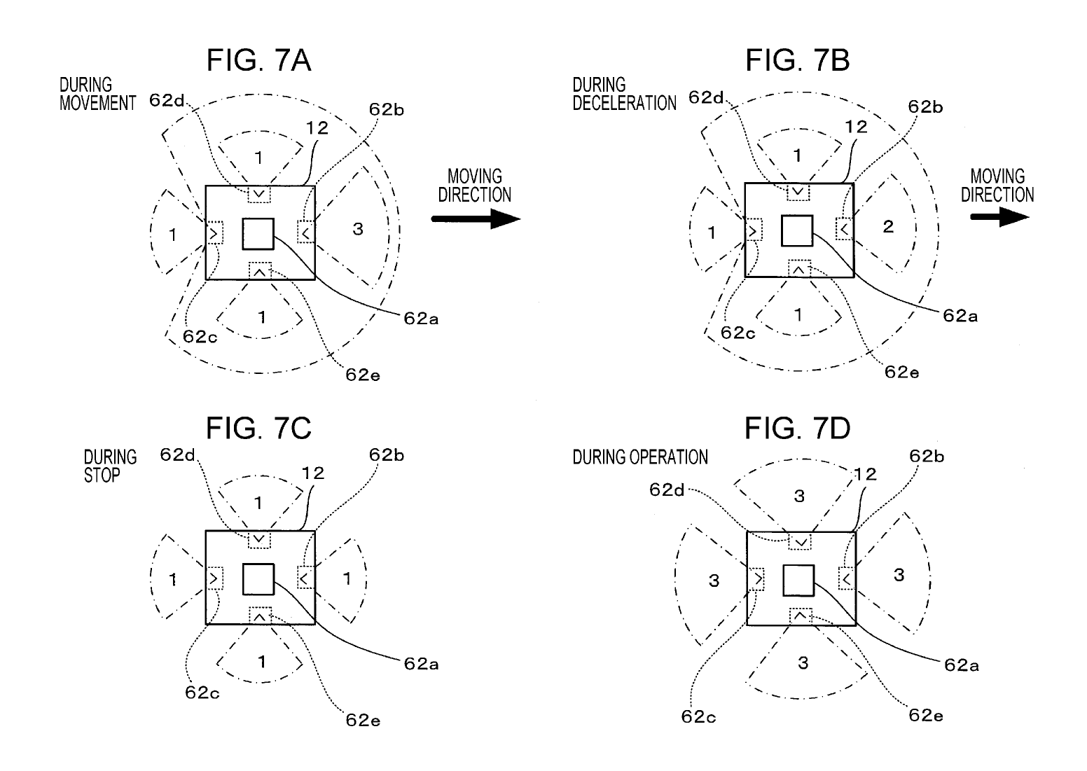

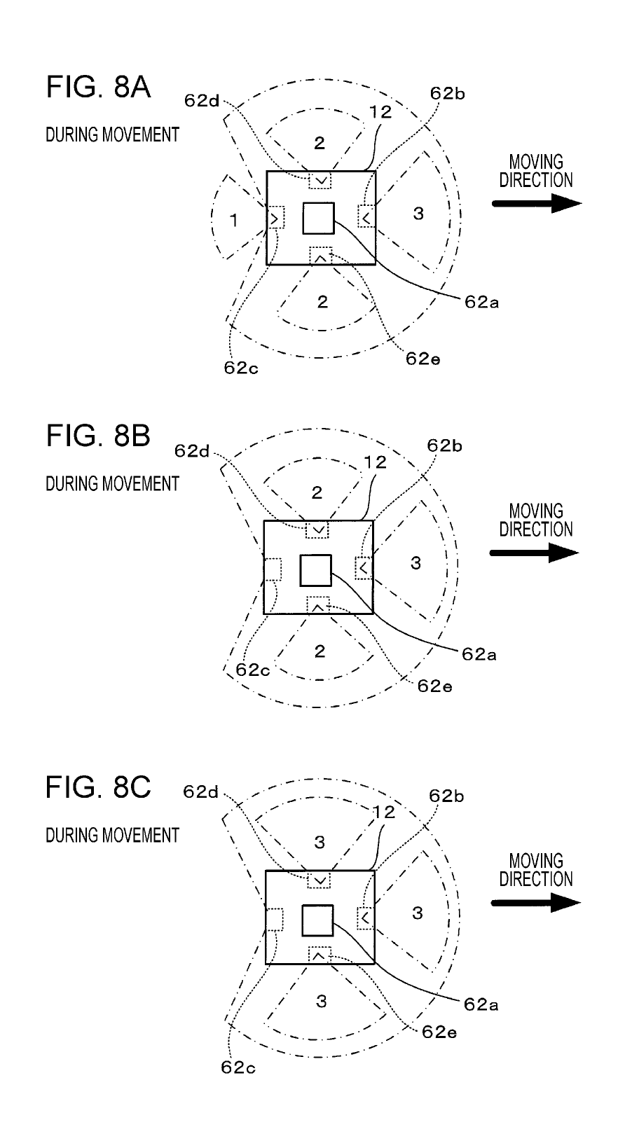

Specifically, as illustrated in FIGS. 7A and 7B and FIGS. 8A to 8C described later, the CPU 52 performs control such that the object detected by the sensor 62a is not detected as an obstacle on the rear side in the opposite direction to the moving direction, to thereby reduce the detection distance on the rear side.

Herein, “to increase the detection distance” refers to changing and increasing the distance to the target to be detected by the sensor. Similarly, “to reduce the detection distance” refers to changing and reducing the distance to the target to be detected by the sensor. Further, “not detected” refers to that the object is not detected by the sensor, and also that the object is detected by the sensor but is excluded (ignored) from information to be processed in processing measures such as stopping the service providing apparatus 12, changing the route, and stopping the operation.

Further, “to increase the detection distance” includes changing and extending the area to be detected by the sensor, and “to reduce the detection distance” includes changing and reducing the area to be detected by the sensor.

Further, during movement, deceleration, stop, and operation of the service providing apparatus 12, the CPU 52 controls the sensors 62a, 62b-1, 62b-2, 62b-3, 62c-1, 62c-2, 62c-3, 62d-1, 62d-2, 62d-3, 62e-1, 62e-2, 62e-3, and 62f to change the respective detection distances to detect an obstacle.

Further, in accordance with the moving speed of the service providing apparatus 12, the CPU 52 controls the sensors 62a, 62b-1, 62b-2, 62b-3, 62c-1, 62c-2, 62c-3, 62d-1, 62d-2, 62d-3, 62e-1, 62e-2, 62e-3, and 62f to change the respective detection distances to detect an obstacle. For example, the CPU 52 performs control to reduce the detection distance of the sensor 62b in the moving direction in accordance with a reduction in the moving speed of the service providing apparatus 12. The CPU 52 further performs control to reduce the detection distance of the sensor 62c in the opposite direction to the moving direction in accordance with an increase in the moving speed of the service providing apparatus 12.

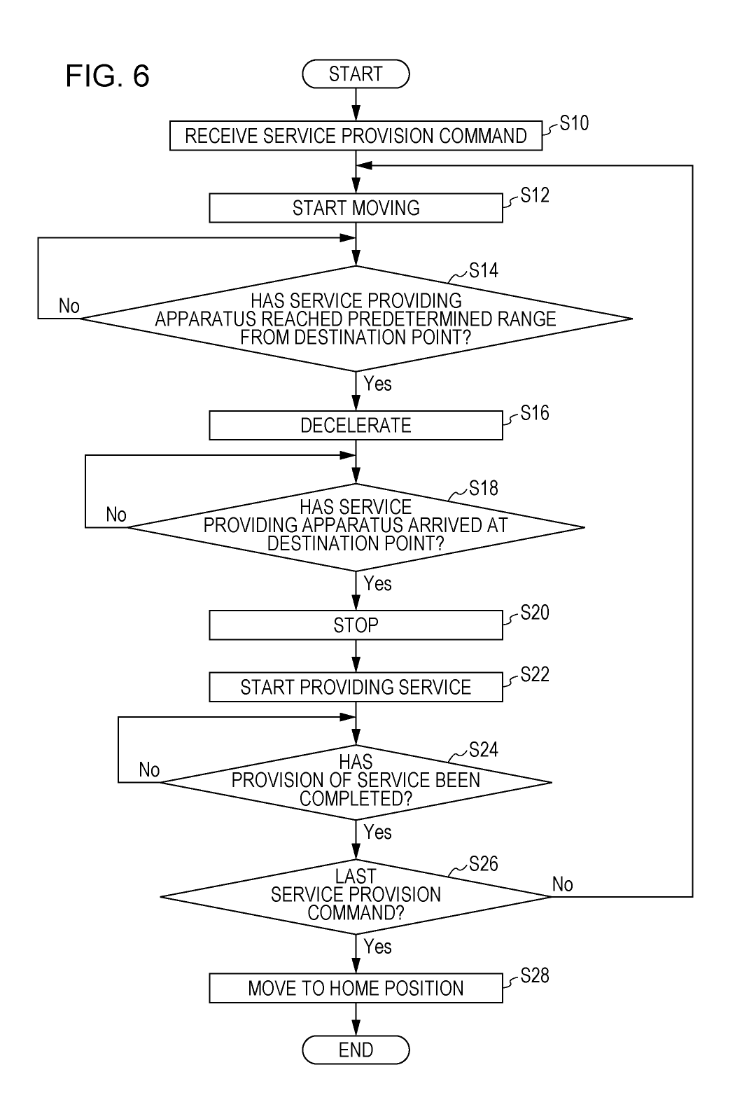

FIG. 6 is a flowchart illustrating an operation of the service providing apparatus 12. FIGS. 7A to 7D are top views of the service providing apparatus 12, schematically illustrating respective detection operations of the sensor 62 during the movement, deceleration, stop, and operation.

In FIGS. 7A to 7D, dash-dotted lines indicate respective detection ranges of the sensors 62a, 62b, 62c, 62d, and 62e provided on the respective surfaces of the service providing apparatus 12. Further, in FIGS. 7A to 7D, the state in which the respective power supplies of the sensors 62b-1, 62c-1, 62d-1, and 62e-1 with the short detection distance are on and the power supplies of the other sensors are off on the respective surfaces is illustrated as detection level 1. The state in which the respective power supplies of the sensors 62b-2, 62c-2, 62d-2, and 62e-2 with the intermediate detection distance are on and the power supplies of the other sensors are off on the respective surfaces is illustrated as detection level 2. The state in which the respective power supplies of the sensors 62b-3, 62c-3, 62d-3, and 62e-3 with the long detection distance are on and the power supplies of the other sensors are off on the respective surfaces is illustrated as detection level 3.

Information related to users and service provision is first output from the PCs 20a to 20c of the users to the internal server 22, which issues the move command to the service providing apparatus 12.

Then, at step S10, the service providing apparatus 12 receives the move command from the internal server 22 (receives a service provision command). At step S12, based on the position information acquired from the internal server 22, the service providing apparatus 12 then moves (starts moving) to the place of issuance of an order for coffee, for example (the destination point).

In this step, the CPU 52 turns on the power supply of the sensor 62b-3 with the long detection distance in the sensor 62b on the front surface of the service providing apparatus 12 in the moving direction (detection level 3 in FIG. 7A), to thereby perform control to detect an obstacle far from the service providing apparatus 12 in the moving direction.

The CPU 52 further turns on the respective power supplies of the sensors 62d-1 and 62e-1 with the short detection distance in the sensors 62d and 62e on the side surfaces of the service providing apparatus 12 (detection level 1 in FIG. 7A), to thereby perform control to reduce the detection distance on the lateral sides of the service providing apparatus 12.

The CPU 52 further turns on the power supply of the sensor 62c-1 with the short detection distance in the sensor 62c on the rear surface of the service providing apparatus (detection level 1 in FIG. 7A), to thereby perform control to reduce the detection distance on the rear side of the service providing apparatus 12 in the opposite direction to the moving direction. This is because, even if an obstacle is detected on the rear side of the service providing apparatus 12, the possibility of the obstacle colliding with the service providing apparatus 12 is lower than that in the moving direction.

Further, although the sensor 62a performs the detection all around the service providing apparatus 12, the CPU 52 performs control such that the obstacle on the rear surface side (the rear side) in the opposite direction to the moving direction is not detected as the obstacle, considering that there is no possibility of the obstacle colliding with the service providing apparatus 12.

That is, the CPU 52 reduces the detection distance on the rear side of the service providing apparatus 12 in the opposite direction to the moving direction so as not to detect an obstacle that would not block the movement of the service providing apparatus 12 and unlikely to collide with the service providing apparatus 12. The CPU 52 further increases the detection distance on the front side of the service providing apparatus 12 in the moving direction to facilitate the detection of an obstacle and prevent the collision with the obstacle.

Further, if the service providing apparatus 12 approaches the destination point, reaches a predetermined range of 1 m to 2 m, for example, from the destination point, and the distance from the service providing apparatus 12 to the destination point identified by the sensors 62a and 62b equals or falls below a threshold (Yes at step S14), the CPU 52 controls the service providing apparatus 12 to decelerate (step S16).

In this step, the CPU 52 performs control to turn off the power supply of the sensor 62b-3 and turn on the power supply of the sensor 62b-2 in the sensor 62b on the front surface of the service providing apparatus 12 in the moving direction (detection level 2 in FIG. 7B). That is, the CPU 52 performs control to make the detection distance in the moving direction shorter during the deceleration than during the movement of the service providing apparatus 12.

Similarly as during the movement, the CPU 52 performs control to turn on the respective power supplies of only the sensors 62d-1 and 62e-1 and the sensor 62c-1 with the short detection distance in the sensors 62d and 62e and the sensor 62c on the side surfaces and the rear surface of the service providing apparatus 12, respectively (detection level in FIG. 7B).

Further, similarly as during the movement, although the sensor 62a performs the detection all around the service providing apparatus 12, the CPU 52 performs control such that the obstacle on the rear surface side (the rear side) in the opposite direction to the moving direction is not detected as the obstacle, considering that there is no possibility of the obstacle colliding with the service providing apparatus 12.

Then, if the service providing apparatus 12 arrives at the destination point (Yes at step S18), the CPU 52 controls the service providing apparatus 12 to stop (step S20).

In this step, the CPU 52 performs control to turn off the power supply of the sensor 62a of the service providing apparatus 12 and turn on the respective power supplies of only the sensors 62b-1, 62c-1, 62d-1, and 62e-1 with the short detection distance in the sensors 62b, 62c, 62d, and 62e on the respective surfaces of the service providing apparatus 12 (detection level 1 in FIG. 7C). That is, if the service providing apparatus 12 stops at the destination point, the CPU 52 performs control to make the detection distance from each of the surfaces of the service providing apparatus 12 shorter than that during the deceleration.

Then, at the next step S22, the service providing apparatus 12 starts providing the service in response to receipt of the input information of the user by the input and output unit 56.

Specifically, if the user brings an ID card into contact with the service providing apparatus 12 and the ID of the user acquired by the service providing apparatus 12 matches an authentication ID of the user stored in the database 74 of the internal server 22, or if facial recognition of the user is performed with the camera of the service providing apparatus 12 and the recognized face acquired by the service providing apparatus 12 matches an authenticated face of the user stored in the database 74 of the internal server 22, for example, the service providing apparatus 12 identifies the person to be provided with the service, acquires the information related to the identified user, and starts providing the service, such as the extraction of coffee, for example.

In this step, the CPU 52 performs control to turn off the power supply of the sensor 62a of the service providing apparatus 12 and turn on the respective power supplies of the sensors 62b-3, 62c-3, 62d-3, and 62e-3 with the long detection distance in the sensors 62b, 62c, 62d, and 62e on the respective surfaces of the service providing apparatus (detection level 3 in FIG. 7D). That is, the CPU 52 performs control to increase the detection distance from each of the surfaces of the service providing apparatus 12.

If an obstacle is detected, the CPU 52 determines the possibility of the detected obstacle colliding with the service providing apparatus 12. In this determination, the CPU 52 determines the probability of the detected obstacle colliding with the service providing apparatus 12 based on the relative moving direction and speed of the obstacle to those of the service providing apparatus 12. If the probability equals or exceeds a predetermined threshold, the CPU 52 determines that the obstacle would collide with the service providing apparatus 12. The CPU 52 may make the determination with results of machine learning of collision cases and non-collision cases.

Further, if the detected obstacle is a dynamic obstacle, the CPU 52 detects the gaze of the detected dynamic obstacle. If the CPU 52 is unable to identify the gaze directed to the service providing apparatus 12, the CPU 52 determines that the obstacle would collide with the service providing apparatus 12.

Further, the CPU 52 determines the possibility of collision by changing the threshold of the possibility of collision in accordance with the contents of the operation. Specifically, in accordance with an increase in influence of vibration on the operation, the CPU 52 extends the detection range, increases the threshold of the possibility of collision, and changes the threshold in accordance with the speed of the dynamic obstacle. In the coffee extracting operation, for example, the CPU 52 extends the detection range and increases the threshold of the possibility of collision as compared with in an environmental information collecting operation, and changes the threshold in accordance with the speed of the dynamic obstacle.

Further, for each of contents of plural different operations, the range of detection to be performed may previously be stored in the storage device 60 as data of a lookup table. In this case, the service providing apparatus 12 identifies the contents of the operation of the service to be provided in accordance with settings made by an administrator, for example. For the identified contents of the operation, the service providing apparatus 12 refers to the data of the lookup table stored in the storage device 60, and thereby identifies the detection range corresponding to the identified contents of the operation, and determines the identified detection range as the range of detection to be performed.

For example, the influence of vibration on the coffee extracting operation is greater than that on the environmental information collecting operation. For the coffee extracting operation, therefore, a detection range wider than a detection range for the environmental information collecting operation is stored as the data of the lookup table. Further, if the coffee extracting operation is set by the administrator as the service to be provided, the service providing apparatus 12 refers to the data of the coffee extracting operation in the lookup table stored in the storage device 60, and thereby determines the detection range corresponding to the coffee extracting operation as the range of detection to be performed.

The thus-determined detection range may be changed in accordance with the moving speed of the service providing apparatus 12. In this case, an expansion range or an expansion rate of the detection range according to the speed of the service providing apparatus 12 may previously be stored in the storage device 60 as data of a lookup table. Then, the service providing apparatus 12 may refer to the expansion range or expansion rate to change the detection range by grasping the degree of change to be made. For example, data for increasing the expansion range or the expansion rate of the detection range in accordance with the increase in the speed may be stored in the storage device 60 as a lookup table. Then, the service providing apparatus 12 may refer to such a lookup table at predetermined time intervals to check the speed during the movement and extend the detection range in accordance with the increase in the speed.

Then, after an obstacle is detected, the CPU 52 controls the service providing apparatus 12 to take a collision avoidance action, such as emitting an alarm sound, issuing a warning with light, starting a stopping operation if during the movement, not starting the operation before the obstacle moves away from the service providing apparatus 12 or stops, stopping the operation if during the operation, or warning the obstacle by radio if the obstacle is a self-propelled apparatus, for example.

At the next step S24, the CPU 52 determines whether or not the provision of the service has been completed.

The service providing apparatus 12 includes a target object detecting sensor that, if the service providing apparatus 12 serves coffee, for example, detects separation of a coffee cup as a target object from the service providing apparatus 12. If the target object detecting sensor detects that the coffee cup has been separated from the service providing apparatus 12, or if the extraction of coffee has been completed, for example, the CPU 52 determines that the provision of the service has been completed (Yes at step S24).

If the provision of the service is completed, the CPU 52 performs control to reduce the detection distance of the sensor 62c in the opposite direction to the moving direction, as illustrated in FIG. 7A (detection level 1 in FIG. 7A), and controls the sensors 62a not to detect an obstacle on the rear surface side (the rear side) in the opposite direction to the moving direction as an obstacle, considering that there is no possibility of the obstacle colliding with the service providing apparatus 12. At the next step S26, the CPU 52 determines whether or not the received service provision command is the last one. If the received service provision command is not the last one, the CPU 52 returns to step S12 to control the service providing apparatus 12 to move to the place for providing the next service (the destination point), with the current position of the service providing apparatus 12 set as the departure point.

If the CPU 52 determines at step S26 that the service provision command is the last one (Yes at step S26), the CPU 52 proceeds to step S28 to control the service providing apparatus 12 to move to the home position. Thereby, the process is completed.

Modified examples of the detection operation of the service providing apparatus 12 will now be described.

FIGS. 8A to 8C are diagrams illustrating modified examples of the detection operation of the service providing apparatus 12 during the movement thereof.

As illustrated in FIG. 8A, the CPU 52 may turn on the power supply of the sensor 62b-3 with the long detection distance in the sensor 62b on the front surface of the service providing apparatus 12 in the moving direction (detection level 3), and turn on the respective power supplies of the sensors 62d-2 and 62e-2 in the sensors 62d and 62e, respectively, on the side surfaces of the service providing apparatus 12 (detection level 2). The CPU 52 may further turn on the power supply of the sensor 62c-1 with the short detection distance in the sensor 62c on the rear surface of the service providing apparatus 12 in the opposite direction to the moving direction (detection level 1), to thereby perform control to make the detection distance of each of the sensors 62d and 62e on the side surfaces of the service providing apparatus 12 longer than the detection distance of the sensor 62c on the rear surface of the service providing apparatus 12. In this case, the CPU 52 prevents the object detected by the sensor 62a from being detected as an obstacle on the rear side in the opposite direction to the moving direction, to thereby perform control to reduce the detection distance on the rear side.

Further, as illustrated in FIG. 8B, the CPU 52 may turn on the power supply of the sensor 62b-3 with the long detection distance in the sensor 62b on the front surface of the service providing apparatus 12 in the moving direction (detection level 3), and turn on the respective power supplies of the sensors 62d-2 and 62e-2 in the sensors 62d and 62e, respectively, on the side surfaces of the service providing apparatus 12 (detection level 2). The CPU 52 may further turn off all power supplies of the sensor 62c on the rear surface of the service providing apparatus 12 in the opposite direction to the moving direction, to thereby perform control not to perform the detection on the rear side of the service providing apparatus 12. In this case, the CPU 52 performs control to prevent the object detected by the sensor 62a from being detected as an obstacle on the rear side in the opposite direction to the moving direction.

Further, as illustrated in FIG. 8C, the CPU 52 may turn on the power supply of the sensor 62b-3 with the long detection distance in the sensor 62b on the front surface of the service providing apparatus 12 in the moving direction and the respective power supplies of the sensors 62d-3 and 62e-3 with the long detection distance in the sensors 62d and 62e, respectively, on the side surfaces of the service providing apparatus 12 (detection level 3). The CPU 52 may further turn off all power supplies of the sensor 62c on the rear surface of the service providing apparatus 12 in the opposite direction to the moving direction, to thereby perform control not to perform the detection on the rear side of the service providing apparatus 12. In this case, the CPU 52 performs control to prevent the object detected by the sensor 62a from being detected as an obstacle on the rear side in the opposite direction to the moving direction.

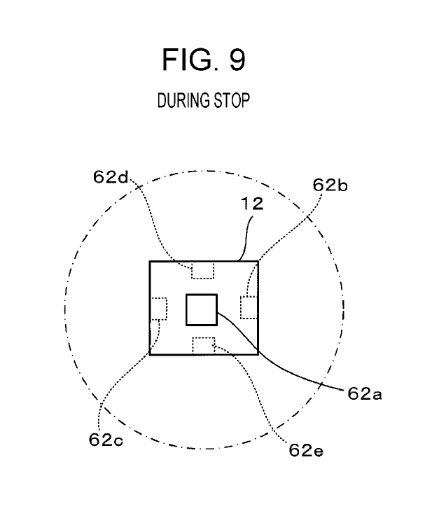

FIG. 9 is a diagram illustrating a modified example of the detection operation of the service providing apparatus 12 during the stop thereof.

As illustrated in FIG. 9, during the stop of the service providing apparatus 12, the CPU 52 may control the sensor 62a to perform the detection all around the service providing apparatus 12, and may perform control to turn off all power supplies of the sensors 62b, 62c, 62d, and 62e on the respective surfaces of the service providing apparatus 12.

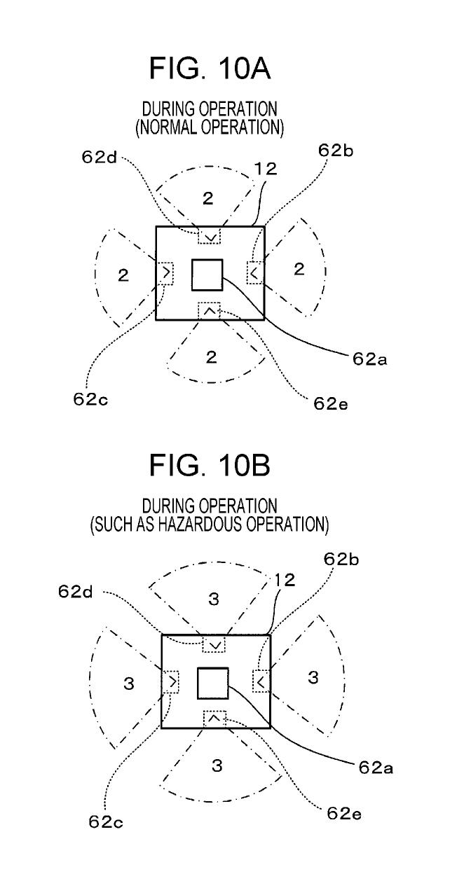

FIGS. 10A and 10B are diagrams illustrating modified examples of the detection operation of the service providing apparatus 12 during the operation (during the service provision) thereof. FIG. 10A is a diagram illustrating a detection operation of the service providing apparatus 12 during a normal operation. FIG. 10B is a diagram illustrating a detection operation of the service providing apparatus 12 during an operation such as a hazardous operation.

As illustrated in FIG. 10A, during the operation of the service providing apparatus 12, the CPU 52 may perform control to turn off the power supply of the sensor 62a and turn on the respective power supplies of only the sensors 62b-2, 62c-2, 62d-2, and 62e-2 in the sensors 62b, 62c, 62d, and 62e on the respective surfaces of the service providing apparatus 12 (detection level 2 on each of the surfaces). That is, during the normal operation, the CPU 52 may make the detection distance of each of the sensors on the respective surfaces shorter than that during an operation such as the hazardous operation illustrated in FIG. 10B. That is, the CPU 52 may perform control to change the detection distance of each of the sensors on the respective surfaces in accordance with the contents of the operation.

Herein, the hazardous operation refers to an operation affected by vibration, such as, for example, the operation of extracting coffee, the operation of delivering a cake, or the operation of collecting environmental information such as the indoor temperature and noise in the present exemplary embodiment. Further, the normal operation refers to an operation unaffected by vibration, such as the operation of a mobile snack serving apparatus or a printer, for example.

That is, in an operation such as the hazardous operation, the CPU 52 controls the detection distance from each of the surfaces to be longer than that in the normal operation. This is because the operation of extracting coffee, for example, is hazardous in that the collision during the operation may result in splatter of hot water to the service providing apparatus 12 and surroundings thereof, for example, and thus it is necessary to detect an obstacle at an earlier stage.

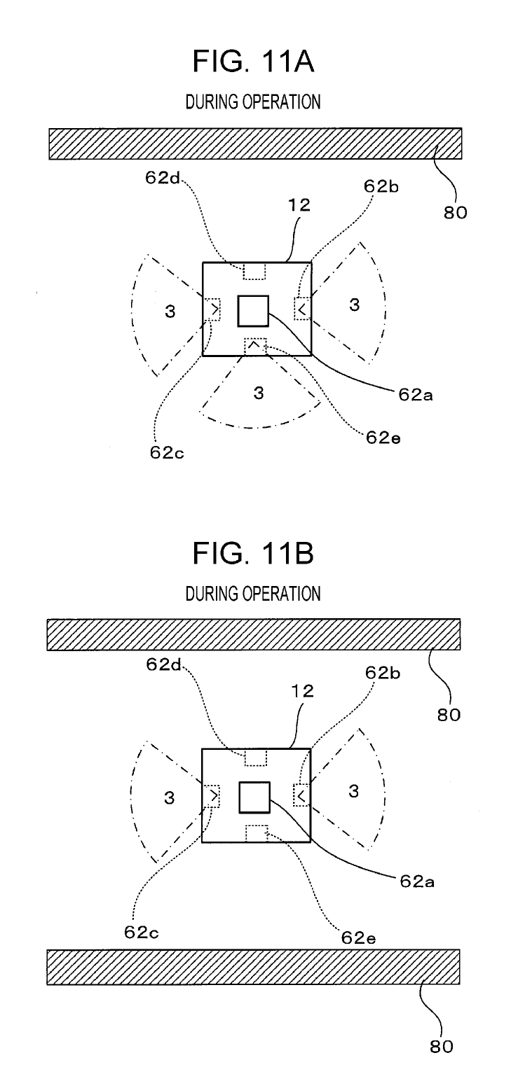

FIGS. 11A and 11B are diagrams illustrating cases in which the service providing apparatus 12 performs the operation in a place where the service providing apparatus 12 faces a wall 80.

If the service providing apparatus 12 faces the wall 80, as illustrated in FIG. 11A, the CPU 52 turns off the respective power supplies of the sensor 62a and the sensor 62d on the wall side of the service providing apparatus 12, to thereby perform control not to detect the wall 80. The CPU 52 further performs control to turn on the respective power supplies of the sensors 62b-3, 62c-3, and 62e-3 with the long detection distance in the sensors 62b, 62c, and 62e each facing an aisle (detection level 3). Depending on the contents of the operation, the CPU 52 may make the detection distance of each of the sensors 62b, 62c, and 62e shorter than that illustrated in FIG. 11A.

Further, if the service providing apparatus 12 faces walls 80, as illustrated in FIG. 11B, the CPU 52 turns off the respective power supplies of the sensor 62a and the sensors 62d and 62e on the wall sides of the service providing apparatus 12, to thereby perform control not to detect the walls 80. The CPU 52 further performs control to turn on the respective power supplies of the sensors 62b-3 and 62c-3 with the long detection distance in the sensors 62b and 62c each facing an aisle (detection level 3). Depending on the contents of the operation, the CPU 52 may make the detection distance of each of the sensors 62b and 62c shorter than that illustrated in FIG. 11B.

That is, as illustrated in FIGS. 11A and 11B, based on the map information of the office 34 received from the internal server 22 and the detection by the sensors 62a, 62b, 62c, 62d, and 62e, the CPU 52 performs control not to perform the detection or extend the detection range in the direction of a static obstacle, such as the wall 80 or a desk, but to extend the detection range in the direction of an aisle on the path on which the service providing apparatus 12 moves or at the destination point.

In the foregoing exemplary embodiment, a description has been given of the service of providing foods and drinks. However, the present invention is not limited thereto. The present invention is also applicable to the provision of stationery and medical supplies and snacks and cakes in an office, the provision of parts and tools in a factory, the operation of collecting the environmental information such as the indoor temperature and noise, and a cleaning service, let alone a printing service.

Further, in the foregoing exemplary embodiment, the laser sensor using laser light has been described as the sensor 62. However, the sensor 62 is not limited thereto, and may employ a device such as an infrared sensor, an ultrasonic sensor, a millimeter wave sensor, an image sensor, or a stereo camera, or may employ a combination of plural types of sensors.

Further, in the foregoing exemplary embodiment, a description has been given of the configuration that changes the detection distance by switching between ON and OFF of the power supplies of the three sensors provided on each of the surfaces of the service providing apparatus 12. However, the configuration is not limited thereto, and each of the surfaces of the service providing apparatus 12 may have two sensors: a short-distance sensor and a long-distance sensor. Further, each of the surfaces of the service providing apparatus 12 may have one sensor, and the output of the sensor provided on each of the front, rear, right, and left surfaces may be changed to change the detection distance (detection range) from the service providing apparatus 12.

Further, in the foregoing exemplary embodiment, a description has been given of the configuration including the sensor 62a that performs the detection all around the service providing apparatus 12 (in 360 degrees), the sensor 62f that performs the detection all around the surroundings of the moving unit 14 below the service providing apparatus 12, and the sensors 62b, 62c, 62d, and 62e provided on the respective surfaces of the service providing apparatus 12. However, the configuration is not limited thereto, and the service providing apparatus 12 may be configured not to include the sensors 62b, 62c, 62d, and 62e on the respective surfaces thereof, but to perform the detection with the sensors 62a and 62f. In this case, the coverage of the sensor 62a, which performs the detection all around the service providing apparatus 12 (in 360 degrees), includes areas blocked and shaded by a housing of the body of the service providing apparatus 12. Further, the coverage of the sensor 62f includes areas blocked and shaded by the moving unit 14 of the service providing apparatus 12. It is desirable that the sensors be installed to complementarily detect blind spot areas created by such shades. Further, the service providing apparatus 12 may be configured not to include the all-around sensors 62a and 62f, but to perform the detection only with the sensors 62b, 62c, 62d, and 62e on the respective surfaces of the service providing apparatus 12.

Further, in the foregoing exemplary embodiment, a description has been given of the configuration in which, if the service providing apparatus 12 reaches the predetermined range from the destination point, the detection distance of the sensor in the moving direction is made shorter than that before the reach. However, the configuration is not limited thereto. If the service providing apparatus 12 reaches the predetermined range from the destination point, the detection distance of the sensor in the moving direction may be made shorter than that before the reach, and the detection distance of the sensor in the opposite direction to the moving direction may be made longer than that before the reach. Further, the detection distance of the sensor in the moving direction may be reduced, and the detection may not be performed on the rear side of the service providing apparatus 12 in the opposite direction to the moving direction.

Further, in the foregoing exemplary embodiment, a description has been given of the configuration in which, if the service providing apparatus 12 reaches the predetermined range from the destination point, the detection distance of the sensor in the moving direction is made shorter than that before the reach. However, the configuration is not limited thereto, and a device that emits radio waves for identifying the destination point, such as a beacon, for example, may be provided at the destination point. Then, in response to receipt of the radio waves or radio waves from a device such as a smartphone, for example, the detection distance of the sensor in the moving direction may be reduced, and the detection distance of the sensor in the opposite direction to the moving direction may be made longer than that before the receipt of the radio waves.

Further, in the foregoing exemplary embodiment, a description has been given of the configuration in which the service is provided (the operation starts) after the stop of the service providing apparatus 12. However, the configuration is not limited thereto, and the service providing apparatus 12 may start the operation before arriving at the destination point. In some cases, the operation takes time. This configuration allows the service providing apparatus 12 to provide the service to the user immediately after arriving at the destination point.

Further, in the foregoing exemplary embodiment, a description has been given of the configuration in which the stop of the service providing apparatus 12 at the destination point is followed by the control to perform the detection on the front, rear, and lateral sides of the service providing apparatus 12 or all around the service providing apparatus 12 and the increase of the detection distance on the rear side of the service providing apparatus 12. However, the configuration is not limited thereto, and the detection distance on the rear side of the service providing apparatus 12 may be increased when the CPU 52 issues an instruction to stop, when the operation starts, when the service providing apparatus 12 approaches the destination point and decelerates, when the radio waves near the destination point are received, or when the distance between the position of the service providing apparatus 12 and the position of the destination point equals or falls below a threshold.

Further, in the foregoing exemplary embodiment, a description has been given of the configuration in which the completion of the operation is determined when the separation of the coffee cup from the service providing apparatus 12 is detected or when the extraction of coffee is completed. However, the configuration is not limited thereto, and the completion of the operation may be determined when it is detected that the user has separated from the service providing apparatus 12 to be outside a predetermined range from the service providing apparatus 12 or when a predetermined time has elapsed, to thereby allow the service providing apparatus 12 to move to the next user or to the home position.

Further, in the foregoing exemplary embodiment, a description has been given of the configuration in which the service providing apparatus 12 moves to the destination point such that the front surface thereof provided with the sensor 62a is in the moving direction. However, the configuration is not limited thereto, and the service providing apparatus 12 may move to the destination point such that any of the surfaces of the service providing apparatus 12 is in the moving direction.

Further, in the foregoing exemplary embodiment, a description has been given of the example in which the service providing apparatus 12 retrieves the travel route based on the map of the office 34 and so forth and the information related to the installation positions of the PCs 20a to 20c, which are stored in the database 74 of the internal server 22. However, the configuration is not limited thereto, and the service providing apparatus 12 may be controlled to move from the departure point to the destination point by retrieving the travel route based on the map of the office 34 and so forth and the information related to the installation positions of the PCs 20a to 20c, which are stored in the storage device 60.

In the foregoing exemplary embodiment, the service providing apparatus 12 is moved to the place equipped with the PCs 20a to 20c. However, the configuration is not limited thereto. For example, the service providing apparatus 12 may be moved to the place specified by the user or to the location of a position transmitter carried by the user.

In the foregoing exemplary embodiment, the mobile drink serving apparatus has been described as an example of the service providing apparatus 12. However, the service providing apparatus 12 is not limited thereto, and may be any mobile service providing apparatus. The present invention is also applicable to an apparatus such as a self-propelled image forming apparatus.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A moving apparatus comprising:
a moving unit that moves to a destination point;
an operation unit that performs a predetermined operation after movement of the moving unit;
a detector that detects an obstacle; and
a controller that controls the detector to make a detection distance in an opposite direction to a moving direction of the moving apparatus shorter during the movement of the moving unit than during the operation of the operation unit.

2. The moving apparatus according to claim 1, wherein, during the movement of the moving unit, the controller controls the detector to make the detection distance in the opposite direction to the moving direction shorter than the detection distance in the moving direction.

3. The moving apparatus according to claim 1, wherein the controller controls the detector not to change the detection distance in the moving direction between during the movement of the moving unit and during the operation of the operation unit.

4. The moving apparatus according to claim 2, wherein the controller controls the detector not to change the detection distance in the moving direction between during the movement of the moving unit and during the operation of the operation unit.

5. The moving apparatus according to claim 1, wherein the controller controls the detector to change the detection distance during the operation of the operation unit in accordance with contents of the operation of the operation unit.

6. The moving apparatus according to claim 5, wherein the controller controls the detector not to change the detection distance during the movement of the moving unit in accordance with the contents of the operation of the operation unit.

7. The moving apparatus according to claim 1, wherein, if the moving apparatus reaches a predetermined range from the destination point, the controller controls the detector to increase the detection distance in the opposite direction to the moving direction.

8. The moving apparatus according to claim 7, wherein the detector includes an identifying unit that identifies a distance from a position of the moving apparatus to the destination point, and
wherein, if the distance identified by the identifying unit equals or falls below a threshold, the controller controls the detector to increase the detection distance in the opposite direction to the moving direction.

9. The moving apparatus according to claim 7, wherein, in response to receipt of radio waves near the destination point, the controller controls the detector to increase the detection distance in the opposite direction to the moving direction.

10. The moving apparatus according to claim 1, further comprising a receiving unit that receives an instruction to start the operation of the operation unit,
wherein, if the receiving unit receives the instruction to start the operation, the controller controls the detector to increase the detection distance in the opposite direction to the moving direction to be longer than the detection distance in the opposite direction to the moving direction before the start of the operation.

11. The moving apparatus according to claim 1, wherein, if the operation of the operation unit is completed, the controller controls the detector to reduce the detection distance in the opposite direction to the moving direction to be shorter than the detection distance in the opposite direction to the moving direction during the operation of the operation unit.

12. The moving apparatus according to claim 11, wherein the detector includes a target object detector that detects separation of a predetermined target object from the moving apparatus, and
wherein, if the target object detector detects the separation of the target object from the moving apparatus, the controller controls the detector to reduce the detection distance in the opposite direction to the moving direction to be shorter than the detection distance in the opposite direction to the moving direction during the operation of the operation unit.

13. The moving apparatus according to claim 1, wherein the controller controls the detector to make the detection distance in the moving direction longer than the detection distance in the opposite direction to the moving direction.

14. The moving apparatus according to claim 1, wherein the controller controls the detector to change the detection distance in accordance with a speed of the moving apparatus.

15. The moving apparatus according to claim 14, wherein the controller controls the detector to reduce the detection distance in the moving direction in accordance with a reduction in the speed of the moving apparatus.

16. The moving apparatus according to claim 14, wherein the controller controls the detector to reduce the detection distance in the opposite direction to the moving direction in accordance with an increase in the speed of the moving apparatus.

17. The moving apparatus according to claim 15, wherein the controller controls the detector to reduce the detection distance in the opposite direction to the moving direction in accordance with an increase in the speed of the moving apparatus.
